(19) United States
(12) Patent Application Publication
(10) Pub. No.: US 2011/0126622 A1
(43) Pub. Date: Jun. 2, 2011

(54) APPARATUS AND METHOD FOR MONITORING PROJECTILE EMISSION AND CHARGING AN ENERGY STORAGE DEVICE

(76) Inventor: Brian P. Turner, Gaithersburg, MD (US)

(21) Appl. No.: 13/056,688

(22) PCT Filed: May 28, 2010
(86) PCT No.: PCT/US10/01571

§ 371 Date: Jan. 31, 2011

Related U.S. Application Data
(60) Provisional application No. 61/182,652, filed on May 29, 2009.

(51) Int. Cl. G01P 15/08; F41A 9/62; F41A 19/10; F41A 17/08; H02K 7/18

(52) U.S. Cl. 73/514.01; 42/1.01; 42/1.02; 290/1 R

(57) ABSTRACT

An apparatus is provided for monitoring projectile emission. The apparatus includes a device configured to emit a projectile. The apparatus also includes a sensor unit including an accelerometer. The accelerometer is configured to output a first signal indicative of an acceleration caused by the emission of the projectile by the device. The apparatus includes a processor unit configured to generate and output a second signal indicating whether the projectile has been emitted, based on the first signal output from the accelerometer.

### PRIORITY

This application claims priority to U.S. Provisional Application No. 61/182,652, filed May 29, 2009, the disclosure of which is incorporated herein by reference in its entirety.

### FIELD

The present disclosure relates generally to devices for use with projectile emitters.

### BACKGROUND

In the modern, era, soldiers carry gear for a variety of uses. For example, soldiers carry various electronic components (e.g., radios) that can require large batteries to operate in a continuous fashion. However, each component carried by a soldier has a cost, both in the financial sense as well as the maneuverability of the soldier in the field. Accordingly, it would be advantageous to design gear that can have low size, weight, and power requirements.

Furthermore, there are many types of information that squad leaders might want to know in a battle such as a location of objects, ammunition remaining, location of units in relation to enemy or friendly units, and a general awareness of the battlefield situation. Accordingly, it would be advantageous to design gear that a soldier might carry to assist in aggregating data so that the desired information can be determined.

### SUMMARY

An exemplary embodiment of the present disclosure includes an apparatus for monitoring projectile emission. The apparatus includes a sensor unit including an accelerometer. The accelerometer is configured to output a first signal indicative of an acceleration caused by the emission of the projectile by the device. The apparatus also includes a processor unit configured to generate and output a second signal indicating whether the projectile has been emitted, based on the first signal output from the accelerometer.

An exemplary embodiment of the present disclosure includes an apparatus including a device configured to emit a projectile. The apparatus also includes an energy storage unit and a kinetic energy capture device configured to convert kinetic energy from recoil of the device to electrical energy. The kinetic energy capture device is configured to charge the energy storage unit with the converted electrical energy.

An exemplary embodiment of the present disclosure includes a method of charging a energy storage unit. The method includes converting kinetic energy from recoil of a projectile emitter to electrical energy. The method also includes charging the energy storage unit with the converted electrical energy.

### BRIEF DESCRIPTION OF THE DRAWINGS

Other objects, advantages, and features of the present disclosure will become apparent to those skilled in the art upon reading the following detailed description of exemplary embodiments, in conjunction with the accompanying drawings, in which like reference numerals have been used to designate like elements, and in which:

FIG. 1 illustrates an exemplary apparatus represented as a projectile emission control device;

FIG. 2 illustrates an exemplary embodiment represented as a rifle;

FIG. 3 illustrates exemplary use of signals from multiple sensors by a processor unit;

FIG. 4 illustrates an exemplary system for communication of information between devices; and

FIG. 5 illustrates an exemplary implementation in the buttstock of an M4 rifle.

As will be realized, different embodiments can be implemented in accordance with the features disclosed herein, and the described features of the exemplary embodiments disclosed herein are capable of being modified in various respects, all without departing from the scope of the claims. Accordingly, the drawings and descriptions are to be regarded as illustrative in nature and not as restrictive.

### DETAILED DESCRIPTION

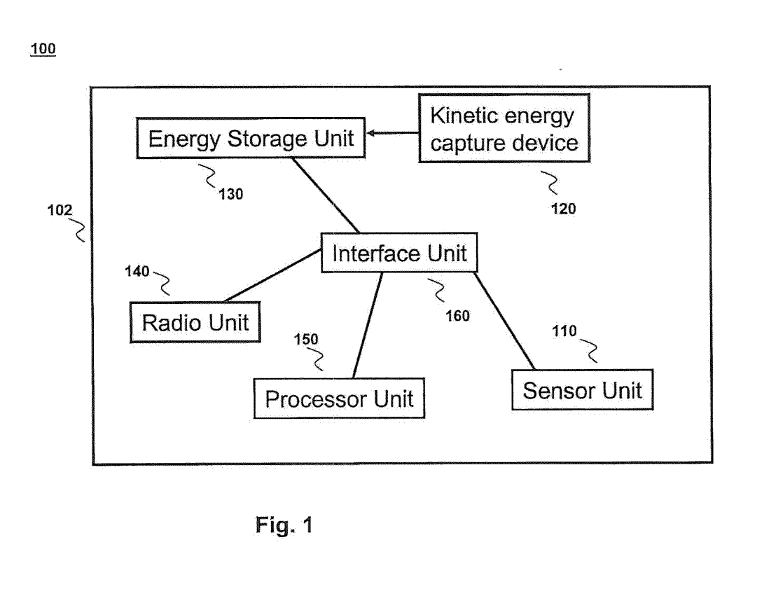

An exemplary embodiment of the present disclosure illustrated in FIG. 1 shows an apparatus represented as a projectile emission control device 100, which includes a housing 102 and components 110, 120, 130, 140, 150, and 160. The components include a sensor unit 110, a kinetic energy capture device 120, an energy storage unit 130, a radio unit 140, a processor unit 150 (e.g., a microcontroller, ARM processor, ASIC, and/or general purpose processor), and an interface unit 160. While FIG. 1 illustrates components 110, 120, 130, 140, 150, and 160, exemplary embodiments can have any combination of one or more of these components with functions of the various components being combined in any desired manner. Any one or more of the components 110, 120, 130, 140, 150, and 160 can be implemented on a single semiconductor substrate or on any number of substrates (i.e., semiconductor chips).

The processor unit 150 executes computer-readable instructions and/or a computer-readable program recorded on a computer-readable recording medium that can be provided in the housing 102. For example, the housing 102 can include a memory unit for accommodating the computer-readable medium as a static component and/or a removable component. The computer-readable recording medium can include, for example, a ROM, a RAM, a flash memory, and/or an optical memory for tangibly storing the computer readable instructions and/or program executed by the processor unit 150.

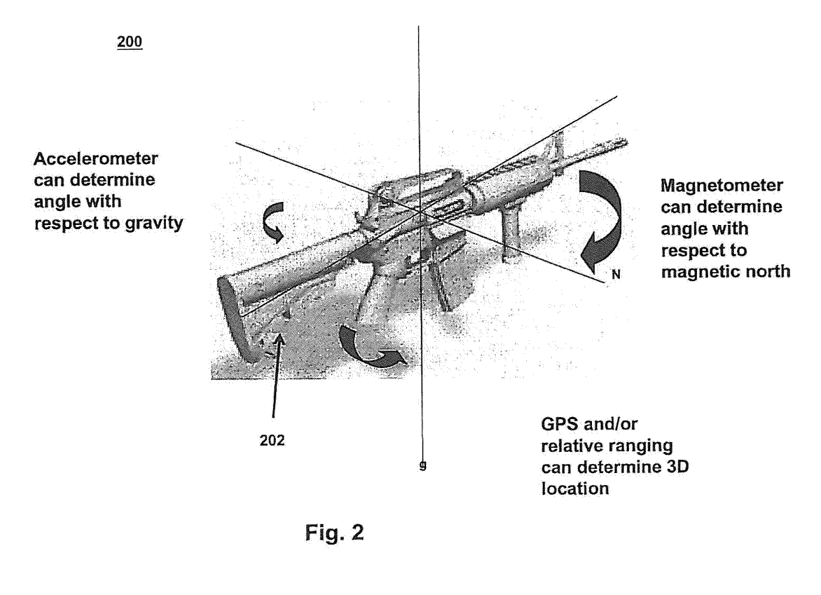

The housing 102 can be a projectile emitter or a part that can be attached to a projectile emitter. The projectile emitter can, for example, be a handheld device. For example, the projectile emitter can be a rifle 200, as illustrated in FIG. 2. The projectile emitter can also be any other type of force generator. When the projectile emitter is configured as a handheld rifle, the projectile emitter can include a buttstock 202 as the housing 102. The housing 102 can include a modular buttstock that can be combined with other parts to form a projectile emitter.

The components mentioned herein do not have to be positioned in a buttstock 202 but rather, can be distributed about the device in any desired manner. In addition, embodiments are contemplated having a kinetic energy capture device 120 located in the housing 102 that can charge an external battery. In another example, at least part of sensor unit 110 can be mounted outside the housing 100. For example, components can be located on other parts of the projectile emitter.

The energy storage unit 130 can store energy for use in the apparatus. For example, the energy storage unit can include a battery (e.g., a Lithium Ion battery) and/or a capacitor.

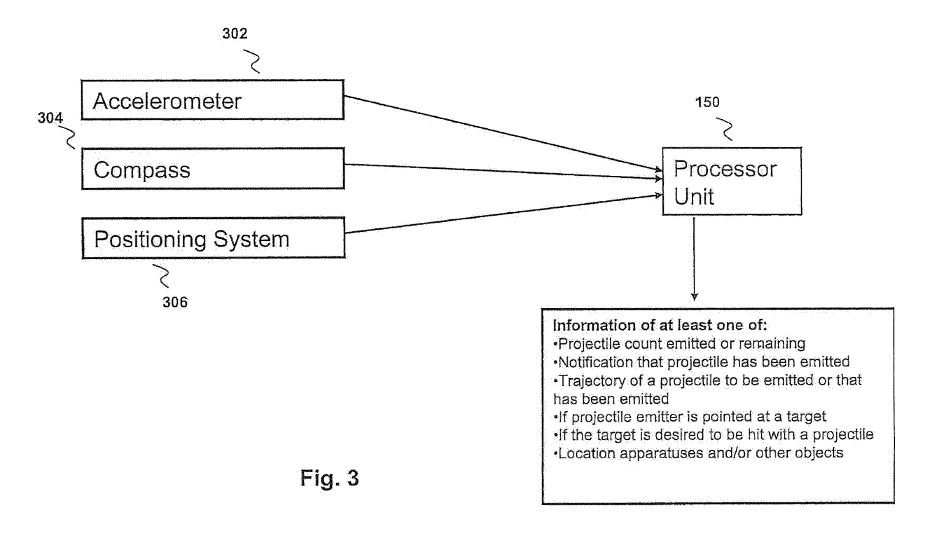

The sensor unit 110 of FIG. 1 can include, as shown in FIG. 3, at least one of a positioning system 306, an accelerometer 302 (e.g., a 3-axis accelerometer), a compass 304 (e.g., a magnetometer, such as a 3-axis magnetometer), Time of Arrival (TOA) transceivers, a microphone, a camera for video or still imagery, and a gyroscope. One or more of these elements can be mounted in a buttstock 202 or elsewhere on a projectile emitter. Signals from one or more parts of the sensor unit 110 can be processed in the processor unit 150 and/or transmitted to outside the device via the interface unit 160.

The positioning system 306 can utilize any known component (e.g., position determination processor and/or GPS receiver) to determine a relative and/or an absolute location of the projectile emitter.

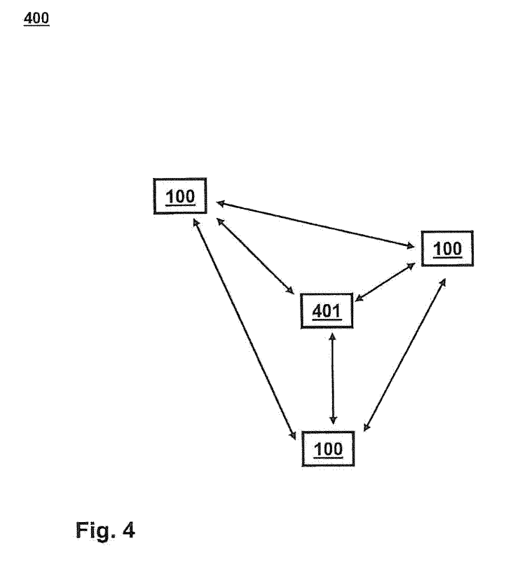

In an exemplary embodiment illustrated in FIG. 4, a system 400 for communication of information can be enabled between multiple ones of the FIG. 1 devices 100. External computers such as server 401, illustrated as server 401 in FIG. 4, can communicate with one or more devices 100. The server 401 can aggregate information from multiple devices 100 to make use of transmitted information. As used herein “aggregate” means to receive and process. For example, locations of objects (e.g., apparatuses and/or targets) can received and processed so as to be displayed on a map.

In accordance with an exemplary embodiment, the radio unit 140 can communicate via ultra wide band communications. In an exemplary embodiment of the radio unit 140 illustrated in FIG. 1, short pulse radios can be used. Communication via the radio unit 140 can, for example, be encrypted. Any known networking and/or encryption standard can be used to interconnect the devices 100 and the FIG. 4 server 401. For example, mesh networking can be used. In exemplary embodiments, a personal area network (PAN) can be formed to enable data communications between any of the multiple devices 100 and the server 401. This communication can enable data (e.g., voice, text, sensor data, or determinations based on sensor data) communication between, for example, multiple devices 100.

In exemplary embodiments, data about at least one of a location, ammunition status (e.g., ammunition spent or ammunition remaining), a report that a shot has been fired, and the trajectory of a fired shot or a shot to be fired can be communicated. This data can be output to a user of any of the devices 100 or the server 401 by, for example, a display and/or speaker. Information can be continuously updated and shared between apparatuses 100 and server 401. In exemplary embodiments, location information can be used to locate a lost or stolen projectile emitter. At least one function (e.g., ability to fire) of the projectile emitter can be remotely disabled, if required. For example, the projectile emitter includes a trigger configured to be operated to initiate an emission of the projectile. The processor unit 150 can be configured to disable the trigger based on a determination the projectile is oriented toward a predetermined object. The positioning system 306 and/or accelerometer 302 can be used to determine the speed at which the projectile emitter is traveling in order to determine if a user is running, walking, or on a vehicle.

The interface unit 160 illustrated in FIG. 1 can connect components of the device and/or of multiple devices to enable their cooperation, such as mutual compatibility and/or interoperability. The interface unit 160 is configured to communicate through wired and/or wireless interfaces various devices, including components of the device 100, as shown in FIG. 1. The interface unit can include, for example, a USB interface, a Wireless USB interface, RS-232, 802.11-based wireless networking, Bluetooth, and I2C, or any other known interface. As used herein, the term “interface” means an electronic device or circuit configured to communicate with another device or a plurality of other devices. In addition, an “interface” also encompasses an electronic device or circuit which serves as the point of communicative interaction between two or more devices. When using a wireless interface, the radio unit 140 can be used or a dedicated radio for the interface can be used. The interface unit can be connected to a wired or wireless headset in order to provide information to a user. For example, a Bluetooth headset can be used. The interface unit 160 can also communicate with external computers such as handheld computers and/or a server unit 401. The apparatus 100 can also include a display or be connected to an external display (e.g., of a handheld computer) via the interface unit 160. The display can include a touch screen. Commands can be input to the processor unit 150 by any known method. For example, voice commands can be received through a microphone (e.g., in a wireless headset with a microphone).

Exemplary embodiments of a device as described herein include a kinetic energy capture device 120 of FIG. 1 to, for example, scavenge energy and store it in an energy storage unit 130. The kinetic energy capture device 120 can charge the energy storage unit 130 using energy from movement of the housing 102. The energy storage unit 130 can be internal or external to the housing. The kinetic energy capture device 120 can include an electroactive material, for example, piezo-electric and/or dielectric materials. The piezo-electric and dielectric materials can include ceramic or polymer-based materials. Exemplary embodiments of the kinetic energy capture device 120 can include an electromagnetic harvester. In exemplary embodiments, the kinetic energy capture device 120 can charge the energy storage unit 130 using kinetic energy from the backward momentum (i.e., recoil) caused by emission of a projectile (e.g., firing of a gun). In exemplary embodiments, the kinetic energy capture device 120 can charge the energy storage unit 130 by utilizing energy from movement of the projectile emitter not related to firing. For example, energy can be captured when the projectile emitter is moved (e.g., swayed) by a user.

Exemplary embodiments can monitor projectile emission by using the accelerometer 302. The accelerometer 302 can optionally be the same component as the kinetic energy capture device 120. The accelerometer 302 is configured to output a first accelerometer signal indicative of an acceleration caused the emission of the projectile by the projectile emitter. The processor unit 150 can output a second signal indicating whether the projectile has been output (e.g., fired), based on the first accelerometer signal from the accelerometer 302. In the example of FIG. 2, the recoil from firing a shot can be detected by the accelerometer 302. In exemplary embodiments, the processor unit 150 receives from the accelerometer 302 the first accelerometer signal indicating acceleration of the device. If the indicated acceleration is greater than a threshold, the processor unit 150 can determine that a projectile has been output. In exemplary embodiments, the threshold can be predetermined based on expected acceleration of the device 100 due to recoil.

The processor unit 150 can be configured to maintain, using the second output signal, a count of projectiles output. For example, the computer readable medium can store a counter value indicating a number of projectiles emitted. The counter value can be updated by the processor unit 150 based on the second output signal. The accelerometer 302 and/or the processor unit 150 can be arranged in the buttstock 202 or elsewhere on the rifle 200. The processor unit 150 can be configured to determine a number of projectiles left to fire based on the second output signal. Information about the number of projectiles left and/or number of projectiles emitted can be transmitted through the interface unit 160 to one or more external devices. In exemplary embodiments, the processor unit 150 can inventory ammunition of a projectile emitter based on the second output signal.

In exemplary embodiments, information about the emission of a projectile can be determined by the processor unit 150 and output through the interface. The information about the emission can include at least one of notification that a projectile has been emitted, a location of the emission, and a trajectory of the emission of the projectile. The information can also include any data recorded by the sensor unit 110. For example, video or audio taken surrounding the emission can be output.

The processor unit 150 can determine an orientation and location of the projectile emitter based on an output of the sensor unit 110. An exemplary embodiment of components used in this determination is illustrated in FIG. 3. FIG. 3 illustrates portions of the sensor unit 110 including an accelerometer 302, compass 304, and positioning system 306. The processor unit 150 is connected to the accelerometer 302, compass 304, and positioning system 306 and processes their respective output signals.

The compass 304 is configured to generate and output a third signal indicating at least one of a direction of the projectile emitter and an angle of displacement of the projectile emitter with respect to a reference point. The processor unit 150 is configured to determine the orientation of the device based on the third signal output by the compass 304.

The positioning system 306 can be used to determine the location of the projectile emitter. For example, the positioning system 306 is configured to generate and output a fourth signal indicating a current location of the device. The processor unit 150 is configured to determine the location of the device based on the fourth signal.

The orientation and location can be used to determine where a projectile will be output by the projectile emitter. For example, the processor unit 150 can be configured to determine a trajectory of at least one of an emitted projectile and a projectile to be emitted based on a determined orientation of the device and the determined location of the device. In determining the orientation, the accelerometer 302 can be used by the processor unit 150 to determine an angle with respect to gravity, and the compass 304 can be used by the processor unit 150 to determine the orientation angle with respect to magnetic north. The processor unit 150 can output a target signal in response to the determined orientation and location of the projectile emitter being such that the projectile emitter is pointed at a target. The processor unit 150 can determine a direction of the emitted projectile based on the determined orientation and the output signal. The processor unit 150 can also determine a trajectory of the projectile emitter based on the determined direction of firing and determined location of the projectile emitter.

In exemplary embodiments, the target signal can be output to a user to determine if a target should be hit with a projectile or not. For example, the processor unit 150 can be configured to determine whether the trajectory of the projectile is such that the projectile is oriented towards the predetermined object. If the target is identified by the processor unit 150 as not desirable to hit with a projectile, the processor can emit a warning signal and/or disable projectile emission. This functionality can reduce and/or eliminate friendly fire.

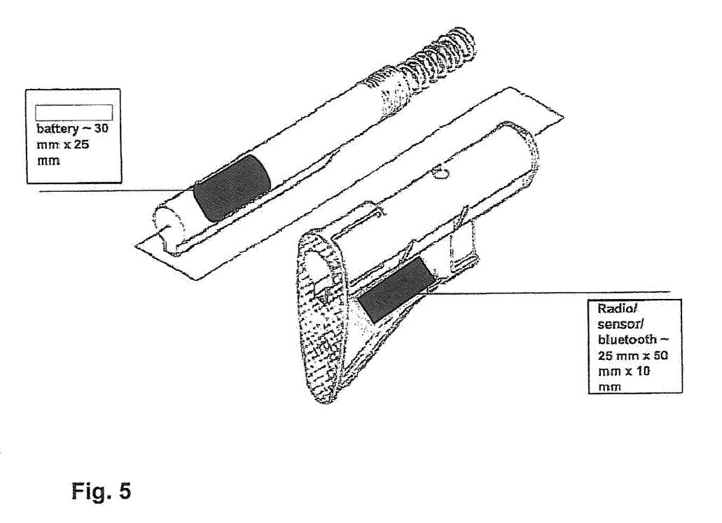

FIG. 5 illustrates an exemplary implementation in a buttstock of an M4. A battery is shown with exemplary measurements arranged in an upper removable portion while sensors, Bluetooth chip, and radio are arranged in a lower portion, with exemplary measurements.

The above description is presented to enable a person skilled in the art to make and use the systems, apparatuses, and methods described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. An apparatus for monitoring projectile emission, comprising:
a device configured to emit a projectile;
a sensor unit including an accelerometer, the accelerometer being configured to output a first signal indicative of an acceleration caused by the emission of the projectile by the device; and
a processor unit configured to generate and output a second signal indicating whether the projectile has been emitted, based on the first signal output from the accelerometer.

2. The apparatus of claim 1, comprising:
a buttstock arranged on the device,
wherein the accelerometer and the processor unit are arranged in the buttstock.

3. The apparatus of claim 1, wherein the processor unit is configured to update a counter value indicating a number of projectiles emitted based on the second signal.

4. The apparatus of claim 3, wherein the processor unit is configured to determine a number of projectiles remaining to be fired based on the second signal.

5. The apparatus of claim 1, wherein the sensor unit comprises a compass configured to generate and output a third signal indicating at least one of a direction of the device and an angle of displacement of the device with respect to a reference point,
wherein the processor unit is configured to determine the orientation of the device based on the third signal output.

6. The apparatus of claim 5, wherein the sensor unit comprises a positioning system configured to generate and output a fourth signal indicating a current location of the device, and
wherein the processor unit is configured to determine the location of the device based on the fourth signal.

7. The apparatus of claim 6, wherein the processor unit is configured to determine a trajectory of at least one of an emitted projectile and a projectile to be emitted based on the determined orientation of the device and the determined location of the device.

8. The apparatus of claim 7, wherein the processor unit is configured to determine whether the trajectory of the projectile is such that the projectile is oriented towards the predetermined object.

9. The apparatus of claim 8, wherein the device comprises a trigger configured to be operated to initiate an emission of the projectile, and
wherein the processor unit is configured to disable the trigger based on the determination that the projectile is oriented towards the predetermined object.

10. The apparatus of claim 1, wherein the processor unit is configured generate the second signal indicating whether the projectile has been emitted by comparing the first signal to a predetermined threshold.

11. The apparatus of claim 1, comprising an energy storage unit,
wherein the accelerometer is configured to convert kinetic energy from recoil of the device to electrical energy, and
wherein the accelerometer is configured to charge the energy storage unit with the converted electrical energy.

12. An apparatus, comprising:
a device configured to emit a projectile;
a kinetic energy capture device configured to convert kinetic energy from recoil of the device to electrical energy; and
an energy storage unit,
wherein the kinetic energy capture device is configured to charge the energy storage unit with the converted electrical energy.

13. A method of charging an energy storage unit, comprising:
converting kinetic energy from recoil of a projectile emitter to electrical energy; and
charging the energy storage unit with the converted electrical energy.

14. The method of claim 13, wherein the projectile emitter is a rifle.
